(19) United States
(12) Patent Application Publication
(10) Pub. No.: US 2017/0091391 A1
(43) Pub. Date: Mar. 30, 2017

(54) Patient Protected Information De-Identification System and Method

(71) Applicant: Parkland Center for Clinical Innovation, Dallas, TX (US)

(72) Inventor: Paea Jean-Francois LePendu, Dallas, TX (US)

(21) Appl. No.: 14/872,059

(22) Filed: Sep. 30, 2015

(51) Int. Cl. G06F 19/00; G06F 21/60; G06F 17/27; G06F 21/62

(52) U.S. Cl. CPC G06F 19/322; G06F 21/6245; G06F 21/602; G06F 17/2705; G06Q 2220/00

(57) ABSTRACT

A computerized system and method of removing protected health information from a patient's medical record include parsing at least one document of a patient's medical record having structured data fields containing the patient's protected health information, generating a dictionary of target patient data that are protected health information, searching and identifying the medical record for all instances of target patient data in the dictionary, and for each identified instance of target patient data in the medical record: determine a random replacement value, replace the target patient data in the medical record with the replacement value, and encrypt and store each unique target patient data and a map to its corresponding replacement value, until all instances of identified target patient data have been replaced with replacement values, and generating a patient's medical record with replacement values in place of all instances of identified target patient data.

### RELATED APPLICATION

This patent application is related to the following patent applications, all of which are incorporated herein by reference:

U.S. Non-Provisional patent application Ser. No. 14/835,698 filed on Aug. 25, 2015, entitled “Clinical Dashboard User Interface System and Method”;

U.S. Non-Provisional patent application Ser. No. 14/798,630 filed on Jul. 14, 2015, entitled “Client Management Tool System and Method”;

U.S. Non-Provisional patent application Ser. No. 14/682,557 filed on Apr. 9, 2015, entitled “Holistic Hospital Patient Care and Management System and Method For Automated Resource Management”;

U.S. Non-Provisional patent application Ser. No. 14/682,610 filed on Apr. 9, 2015, entitled “Holistic Hospital Patient Care and Management System and Method For Patient and Family Engagement”;

U.S. Non-Provisional patent application Ser. No. 14/682,668 filed on Apr. 9, 2015, entitled “Holistic Hospital Patient Care and Management System and Method For Situation Analysis Simulation”;

U.S. Non-Provisional patent application Ser. No. 14/682,705 filed on Apr. 9, 2015, entitled “Holistic Hospital Patient Care and Management System and Method For Automated Staff Monitoring”;

U.S. Non-Provisional patent application Ser. No. 14/682,745 filed on Apr. 9, 2015, entitled “Holistic Hospital Patient Care and Management System and Method”;

U.S. Non-Provisional patent application Ser. No. 14/682,807 filed on Apr. 9, 2015, entitled “Holistic Hospital Patient Care and Management System and Method For Telemedicine”;

U.S. Non-Provisional patent application Ser. No. 14/682,836 filed on Apr. 9, 2015, entitled “Holistic Hospital Patient Care and Management System and Method For Automated Patient Monitoring”;

U.S. Non-Provisional patent application Ser. No. 14/682,866 filed on Apr. 9, 2015, entitled “Holistic Hospital Patient Care and Management System and Method For Enhanced Risk Stratification”;

U.S. Non-Provisional patent application Ser. No. 14/514,164 filed on Oct. 14, 2014, entitled “Intelligent Continuity of Care Information System and Method”;

U.S. Non-Provisional patent application Ser. No. 14/326,863 filed on Jul. 9, 2014, entitled “Patient Care Surveillance System and Method”;

U.S. Non-Provisional patent application Ser. No. 14/018,514 filed on Sep. 5, 2013, entitled “Clinical Dashboard User Interface System and Method”; and

U.S. Non-Provisional patent application Ser. No. 13/613,980 filed on Sep. 13, 2012 and entitled “Clinical Predictive and Monitoring System and Method.”

### FIELD

The present disclosure relates to a patient protected information de-identification system and method, and in particular in the field of electronic medical records.

### BACKGROUND

Protected health information (PHI) or individually identifiable health information is information that was created, used, or disclosed in the course of providing a healthcare service such as diagnosis or treatment that can be used to identify the patient. Section 164.514(a) of the HIPAA Privacy Rule provides the standard for de-identification of protected health information. Under this standard, health information is not individually identifiable if it does not identify an individual and if the covered entity has no reasonable basis to believe it can be used to identify an individual. Because of privacy concerns, HIPAA regulations require strict adherence to the protection and access to this protected information. HIPAA privacy rules allow access and use of patient medical records when necessary for comparative effectiveness studies, policy assessment, life sciences research, and other endeavors. However, data known to contain PHI can be shared or transmitted only under tightly controlled circumstances, typically involving agreements under which the researchers must obtain approval from an institutional review board (IRB) or equivalent for the use of the data.

In order for researchers and others who work with medical record data to use and share the data more freely, the HIPAA Privacy Rule provides two ways that medical records can be de-identified or anonymized: 1) a formal determination by a qualified expert; or 2) the removal of specified individual identifiers as well as absence of actual knowledge by the covered entity that the remaining information could be used alone or in combination with other information to identify the individual. This process, termed de-identification, is a non-trivial, tedious, and error-prone task due to the voluminous and complex nature of the data found in typical medical records.

### BRIEF DESCRIPTION OF THE DRAWINGS

FIG. 1 is a simplified block diagram of an exemplary embodiment of a clinical predictive and monitoring system and method employing a patient protected information de-identification system and method according to the present disclosure;

FIG. 2 is a simplified logical block diagram of an exemplary embodiment of a clinical predictive and monitoring system and method employing a patient protected information de-identification system and method according to the present disclosure;

FIG. 3 is a simplified flowchart of an exemplary embodiment of a patient protected information de-identification system and method according to the present disclosure; and

FIG. 4 is another simplified diagram of an exemplary embodiment of a patient protected information de-identification system and method according to the present disclosure.

### DETAILED DESCRIPTION

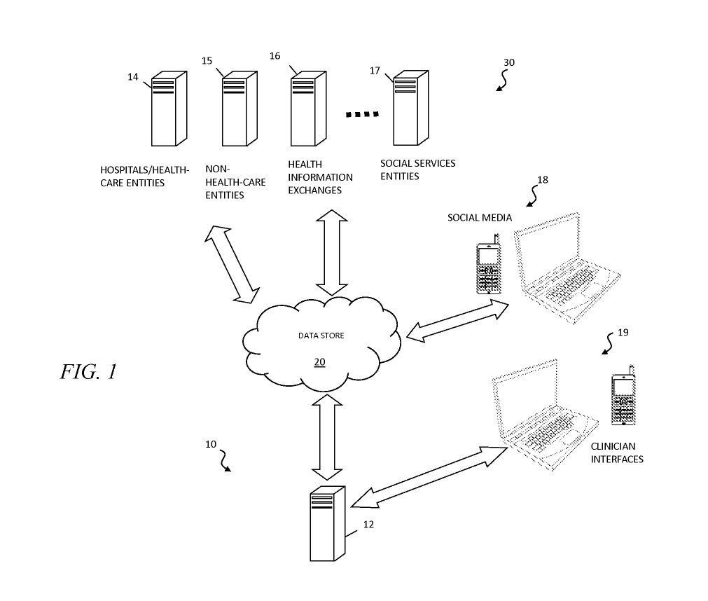

FIG. 1 is a simplified block diagram of an exemplary embodiment of a clinical predictive and monitoring system and method 30 employing a patient protected information de-identification system and method 10 according to the present disclosure. The patient protected information de-identification system 10 includes a computer system 12 adapted to receive a variety of clinical and non-clinical data relating to patients or individuals requiring and receiving care. The variety of data include real-time data streams and historical or stored data from hospitals and healthcare entities 14, non-health care entities 15, health information exchanges 16, and social-to-health information exchanges and social services entities 17, for example. These data may be used to determine a disease risk score for selected patients so that they may receive more targeted intervention, treatment, and care that are better tailored and customized to their particular condition and needs. The clinical predictive and monitoring system 30 is most suited for identifying particular patients who require intensive inpatient and/or outpatient care to avert serious detrimental effects of certain clinical events and to reduce hospital readmission rates. It should be noted that the computer system 12 may comprise one or more local or remote computer servers operable to transmit data and communicate via wired and wireless communication links and computer networks.

The data received by the clinical predictive and monitoring system 30 include electronic medical records (EMR) that include both clinical and non-clinical data. The EMR clinical data may be received from entities such as hospitals, clinics, pharmacies, laboratories, and health information exchanges, including: vital signs and other physiological data; data associated with comprehensive or focused history and physical exams by a physician, nurse, or allied health professional; medical history; prior allergy and adverse medical reactions; family medical history; prior surgical history; emergency room records; medication administration records; culture results; transcribed clinical notes and records; gynecological and obstetric history; mental status examination; vaccination records; radiological imaging exams; invasive visualization procedures; psychiatric treatment history; prior histological specimens; laboratory data; genetic information; physician's notes; networked devices and monitors (such as blood pressure devices and glucose meters); pharmaceutical and supplement intake information; and focused genotype testing.

The EMR non-clinical data may include, for example, social, behavioral, lifestyle, and economic data; type and nature of employment; job history; medical insurance information; hospital utilization patterns; exercise information; addictive substance use; occupational chemical exposure; frequency of physician or health system contact; location and frequency of habitation changes; predictive screening health questionnaires such as the patient health questionnaire (PHQ); personality tests; census and demographic data; neighborhood environments; diet; gender; marital status; education; proximity and number of family or care-giving assistants; address; housing status; social media data; and educational level. The non-clinical patient data may further include data entered by the patients, such as data entered or uploaded to a social media website.

Additional sources or devices of EMR data may provide, for example, lab results, medication assignments and changes, EKG results, radiology notes, daily weight readings, and daily blood sugar testing results. These data sources may be from different areas of the hospital, clinics, patient care facilities, laboratories, patient home monitoring devices, among other available clinical or healthcare sources.

As shown in FIG. 1, patient data sources may include non-healthcare entities 15. These are entities or organizations that are not thought of as traditional healthcare providers. These entities 15 may provide non-clinical data that include, for example, gender; marital status; education; community and religious organizational involvement; proximity and number of family or care-giving assistants; address; census tract location and census reported socioeconomic data for the tract; housing status; number of housing address changes; frequency of housing address changes; requirements for governmental living assistance; ability to make and keep medical appointments; independence on activities of daily living; sensory impairments; cognitive impairments; mobility impairments; educational level; employment; and economic status in absolute and relative terms to the local and national distributions of income; climate data; and health registries. Such data sources may provide further insightful information about patient lifestyle, such as the number of family members, relationship status, individuals who might help care for a patient, and health and lifestyle preferences that could influence health outcomes.

The clinical predictive and monitoring system 30 may further receive data from health information exchanges (HIE) 16. HIEs are organizations that mobilize healthcare information electronically across organizations within a region, community or hospital system. HIEs are increasingly developed to share clinical and non-clinical patient data between healthcare entities within cities, states, regions, or within umbrella health systems. Data may arise from numerous sources such as hospitals, clinics, consumers, payers, physicians, labs, outpatient pharmacies, ambulatory centers, nursing homes, and state or public health agencies.

A subset of HIEs connect healthcare entities to community organizations that do not specifically provide health services, such as non-governmental charitable organizations, social service agencies, and city agencies. The clinical predictive and monitoring system 30 may receive data from these social services organizations and social-to-health information exchanges 17, which may include, for example, information on daily living skills, availability of transportation to doctor appointments, employment assistance, training, substance abuse rehabilitation, counseling or detoxification, rent and utilities assistance, homeless status and receipt of services, medical follow-up, mental health services, meals and nutrition, food pantry services, housing assistance, temporary shelter, home health visits, domestic violence, appointment adherence, discharge instructions, prescriptions, medication instructions, neighborhood status, and ability to track referrals and appointments.

Another source of data include social media or social network services 18, such as FACEBOOK and GOOGLE+ websites. Such sources can provide information such as the number of family members, relationship status, identify individuals who may help care for a patient, and health and lifestyle preferences that may influence health outcomes. These social media data may be received from the websites, with the individual's permission, and some data may come directly from a user's computing device as the user enters status updates, for example.

These non-clinical patient data provides a much more realistic and accurate depiction of the patient's overall holistic healthcare environment. Augmented with such non-clinical patient data, the analysis and predictive modeling performed by the present system to identify patients at high-risk of readmission or disease recurrence become much more robust and accurate.

The clinical predictive and monitoring system 30 is further adapted to receive user preferences and system configuration data from clinicians' computing devices (mobile devices, tablet computers, laptop computers, desktop computers, servers, etc.) 19 in a wired or wireless manner. These computing devices are equipped to display a system dashboard and/or another graphical user interface to present system data and reports configured for an institution (e.g., hospitals and clinics) and individual healthcare providers (e.g., physicians, nurses, and administrators). For example, a clinician (healthcare personnel) may immediately generate a list of patients that have the highest congestive heart failure risk scores, e.g., top n numbers or top x %. The graphical user interface are further adapted to receive the user's (healthcare personnel) input of preferences and configurations, etc. The data may be transmitted, presented, and displayed to the clinician/user in the form of web pages, web-based message, text files, video messages, multimedia messages, text messages, e-mail messages, and in a variety of suitable ways and formats.

As shown in FIG. 1, the clinical predictive and monitoring system 30 may receive and process data streamed real-time, or from historic or batched data from various data sources. Further, the clinical predictive and monitoring system 30 may store the received data in a data store 20 or process the data without storing it first. The real-time and stored data may be in a wide variety of formats according to a variety of protocols, including CCD, XDS, HL7, SSO, HTTPS, EDI, CSV, etc. The data may be encrypted or otherwise secured in a suitable manner. The data may be pulled (polled) by the clinical predictive and monitoring system 30 from the various data sources or the data may be pushed to the system by the data sources. Alternatively or in addition, the data may be received in batch processing according to a predetermined schedule or on-demand. The data store 20 may include one or more local servers, memory, drives, and other suitable storage devices. Alternatively or in addition, the data may be stored in a data center in the cloud.

The computer system 12 may comprise a number of computing devices, including servers, that may be located locally or in a cloud computing farm. The data paths between the computer system 12 and the data store 20 may be encrypted or otherwise protected with a firewall or other security measures and secure transport protocols now known or later developed.

The clinical and non-clinical data that are part of a patient's electronic medical record (EMR) contains protected health information (PHI) that are tightly regulated by HIPAA regulations. Protected health information is most health information in the medical record that can be linked to an identifiable individual. HIPAA regulations currently lists 18 identifiers that are considered protected health information: name, all geographical subdivisions smaller than a state (e.g., street address, city, county, precinct, zip code), month and day of dates relating directly to the patient (e.g., birthdate, admission date, discharge date, date of death), telephone number, fax number, electronic mail address, social security number, medical record number, health plan beneficiary number, account number, certificate/license number, vehicle identifiers (e.g., VIN and license plate number), device identifier and serial number, Internet URL (Uniform Record Locator), IP (Internet Protocol) address number, biometric identifier (e.g., fingerprint, voice print, retina pattern), full-face photographic image, any other unique identifying device. Therefore, scrubbing a patient's medical record means the removal and/or replacement of these 18 identifiers.

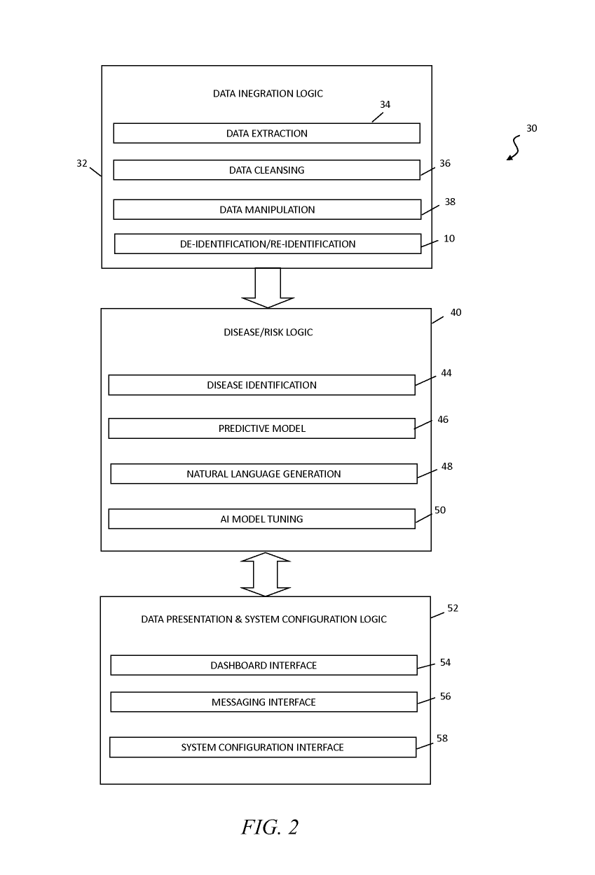

FIG. 2 is a simplified logical block diagram of an exemplary embodiment of a clinical predictive and monitoring system and method 30 that employs the patient protected information de-identification system and method 10. Because the clinical predictive and monitoring system and method 30 receive and extract data from many disparate sources in myriad formats pursuant to different protocols, the incoming data must first undergo a multi-step process before they may be properly analyzed and utilized. The clinical predictive and monitoring system and method 30 includes a data integration logic module 32 that further includes a data extraction process 34, a data cleansing process 36, a data manipulation process 38, and a de-identification/re-identification module 10. It should be noted that although the data integration logic module 32 is shown to have distinct processes 34-38 and 10, these are done for illustrative purposes only and these processes may be performed in parallel, iteratively, and interactively.

The data extraction process 34 extracts clinical and non-clinical data from data sources in real-time or in historical batch files either directly or through the Internet, using various technologies and protocols. Preferably in real-time, the data cleansing process 36 “cleans” or pre-processes the data, putting structured data in a standardized format and preparing unstructured text for natural language processing (NLP) to be performed in the disease/risk logic module 40 described below. The system may also receive “clean” data and convert them into desired formats (e.g., text date field converted to numeric for calculation purposes).

The data manipulation process 38 may analyze the representation of a particular data feed against a meta-data dictionary and determine if a particular data feed should be re-configured or replaced by alternative data feeds. For example, a given hospital EMR may store the concept of “maximum creatinine” in different ways. The data manipulation process 28 may make inferences in order to determine which particular data feed from the EMR would best represent the concept of “creatinine” as defined in the meta-data dictionary and whether a feed would need particular re-configuration to arrive at the maximum value (e.g., select highest value).

The data integration logic module 32 further includes a de-identification/re-identification process 10 that is adapted to remove and replace all protected health information (PHI) according to HIPAA standards. The process 10 is also adapted to re-identify the data in the reverse direction. Protected health information that may be removed and added back may include, for example, name, phone number, facsimile number, email address, social security number, medical record number, health plan beneficiary number, account number, certificate or license number, vehicle number, device number, URL, all geographical subdivisions smaller than a state, including street address, city, county, precinct, zip code, and their equivalent geocodes (except for the initial three digits of a zip code, if according to the current publicly available data from the Bureau of the Census), Internet Protocol number, biometric data, and any other unique identifying number, characteristic, or code.

The data integration logic module 32 then passes the pre-processed data to a disease/risk logic module 40. The disease risk logic module 40 is operable to calculate a risk score associated with an identified disease or condition for each patient and identifying those patients who should receive targeted intervention and care. The disease/risk logic module 40 includes a disease identification process 44. The disease identification process 44 is adapted to identify one or more diseases or conditions of interest for each patient. The disease identification process 44 considers data such as lab orders, lab values, clinical text and narrative notes, and other clinical and historical information to determine the probability that a patient has a particular disease. Additionally, during disease identification, natural language processing is conducted on unstructured clinical and non-clinical data to determine the disease or diseases that the physician believes are prevalent. This process 44 may be performed iteratively over the course of many days to establish a higher confidence in the disease identification as the physician becomes more confident in the diagnosis. New or updated patient data may not support a previously identified disease, and the system would automatically remove the patient from that disease list. The natural language processing combines a rule-based model and a statistically-based learning model.

The disease identification process 44 utilizes a hybrid model of natural language processing, which combines a rule-based model and a statistically-based learning model. During natural language processing, raw unstructured data, for example, physicians' notes and reports, first go through a process called tokenization. The tokenization process divides the text into basic units of information in the form of single words or short phrases by using defined separators such as punctuation marks, spaces, or capitalizations. Using the rule-based model, these basic units of information are identified in a meta-data dictionary and assessed according to predefined rules that determine meaning. Using the statistical-based learning model, the disease identification process 44 quantifies the relationship and frequency of word and phrase patterns and then processes them using statistical algorithms. Using machine learning, the statistical-based learning model develops inferences based on repeated patterns and relationships. The disease identification process 44 performs a number of complex natural language processing functions including text pre-processing, lexical analysis, syntactic parsing, semantic analysis, handling multi-word expression, word sense disambiguation, and other functions.

For example, if a physician's notes include the following: “55 yo m c h/o dm, cri. now with adib rvr, chfexac, and rle cellulitis going to 10W, tele.” The data integration logic 32 is operable to translate these notes as: “Fifty-five-year-old male with history of diabetes mellitus, chronic renal insufficiency now with atrial fibrillation with rapid ventricular response, congestive heart failure exacerbation and right lower extremity cellulitis going to 10 West and on continuous cardiac monitoring.”

Continuing with the prior example, the disease identification process 44 is adapted to further ascertain the following: 1) the patient is being admitted specifically for atrial fibrillation and congestive heart failure; 2) the atrial fibrillation is severe because rapid ventricular rate is present; 3) the cellulitis is on the right lower extremity; 4) the patient is on continuous cardiac monitoring or telemetry; and 5) the patient appears to have diabetes and chronic renal insufficiency.

The disease/risk logic module 40 further comprises a predictive model process 46 that is adapted to predict the risk of particular diseases or condition of interest according to one or more predictive models. For example, if the hospital desires to determine the level of risk for future readmission for all patients currently admitted with heart failure, the heart failure predictive model may be selected for processing patient data. However, if the hospital desires to determine the risk levels for all internal medicine patients for any cause, an all-cause readmissions predictive model may be used to process the patient data. As another example, if the hospital desires to identify those patients at risk for short-term and long-term diabetic complications, the diabetes predictive model may be used to target those patients. Other predictive models may include HIV readmission, diabetes identification, risk for cardio-pulmonary arrest, kidney disease progression, acute coronary syndrome, pneumonia, cirrhosis, all-cause disease-independent readmission, colon cancer pathway adherence, and others.

Continuing to use the prior example, the predictive model for congestive heart failure may take into account a set of risk factors or variables, including the worst values for laboratory and vital sign variables such as: albumin, total bilirubin, creatine kinase, creatinine, sodium, blood urea nitrogen, partial pressure of carbon dioxide, white blood cell count, troponin-I, glucose, internationalized normalized ratio, brain natriuretic peptide, pH, temperature, pulse, diastolic blood pressure, and systolic blood pressure. Further, non-clinical factors are also considered, for example, the number of home address changes in the prior year, risky health behaviors (e.g., use of illicit drugs or substances), number of emergency room visits in the prior year, history of depression or anxiety, and other factors. The predictive model specifies how to categorize and weight each variable or risk factor, and the method of calculating the predicted probably of readmission or risk score. In this manner, the clinical predictive and monitoring system and method 30 is able to stratify, in real-time, the risk of each patient that arrives at a hospital or another healthcare facility. Therefore, those patients at the highest risks are automatically identified so that targeted intervention and care may be instituted. One output from the disease/risk logic module 40 includes the risk scores of all the patients for particular disease or condition. In addition, the module 40 may rank the patients according to the risk scores, and provide the identities of those patients at the top of the list. For example, the hospital may desire to identify the top 20 patients most at risk for congestive heart failure readmission, and the top 5% of patients most at risk for cardio-pulmonary arrest in the next 24 hours. Other diseases and conditions that may be identified using predictive modeling include, for example, HIV readmission, diabetes identification, kidney disease progression, colorectal cancer continuum screening, meningitis management, acid-base management, anticoagulation management, etc.

The disease/risk logic module 40 may further include a natural language generation module 48. The natural language generation module 48 is adapted to receive the output from the predictive model 46 such as the risk score and risk variables for a patient, and “translate” the data to present the evidence that the patient is at high-risk for that disease or condition. This module 40 thus provides the intervention coordination team additional information that supports why the patient has been identified as high-risk for the particular disease or condition. In this manner, the intervention coordination team may better formulate the targeted inpatient and outpatient intervention and treatment plan to address the patient's specific situation.

The disease/risk logic module 40 further includes an artificial intelligence (AI) model tuning process 50. The artificial intelligence model tuning process 48 utilizes adaptive self-learning capabilities using machine learning technologies. The capacity for self-reconfiguration enables the system and method 30 to be sufficiently flexible and adaptable to detect and incorporate trends or differences in the underlying patient data or population that may affect the predictive accuracy of a given algorithm. The artificial intelligence model tuning process 50 may periodically retrain a selected predictive model for improved accurate outcome to allow for selection of the most accurate statistical methodology, variable count, variable selection, interaction terms, weights, and intercept for a local health system or clinic. The artificial intelligence model tuning process 50 may automatically modify or improve a predictive model in three exemplary ways. First, it may adjust the predictive weights of clinical and non-clinical variables without human supervision. Second, it may adjust the threshold values of specific variables without human supervision. Third, the artificial intelligence model tuning process 50 may, without human supervision, evaluate new variables present in the data feed but not used in the predictive model, which may result in improved accuracy. The artificial intelligence model tuning process 50 may compare the actual observed outcome of the event to the predicted outcome then separately analyze the variables within the model that contributed to the incorrect outcome. It may then re-weigh the variables that contributed to this incorrect outcome, so that in the next reiteration those variables are less likely to contribute to a false prediction. In this manner, the artificial intelligence model tuning process 50 is adapted to reconfigure or adjust the predictive model based on the specific clinical setting or population in which it is applied. Further, no manual reconfiguration or modification of the predictive model is necessary. The artificial intelligence model tuning process 50 may also be useful to scale the predictive model to different health systems, populations, and geographical areas in a rapid timeframe.

As an example of how the artificial intelligence model tuning process 50 functions, the sodium variable coefficients may be periodically reassessed to determine or recognize that the relative weight of an abnormal sodium laboratory result on a new population should be changed from 0.1 to 0.12. Over time, the artificial intelligence model tuning process 38 examines whether thresholds for sodium should be updated. It may determine that in order for the threshold level for an abnormal sodium laboratory result to be predictive for readmission, it should be changed from, for example, 140 to 136 mg/dL. Finally, the artificial intelligence model tuning process 50 is adapted to examine whether the predictor set (the list of variables and variable interactions) should be updated to reflect a change in patient population and clinical practice. For example, the sodium variable may be replaced by the NT-por-BNP protein variable, which was not previously considered by the predictive model.

The results from the disease/risk logic module 40 are provided to the hospital personnel, such as the intervention coordination team, and other caretakers by a data presentation and system configuration logic module 52. The data presentation logic module 52 includes a dashboard interface 54 that is adapted to provide information on the performance of the clinical predictive and monitoring system and method 30. A user (e.g., hospital personnel, administrator, and intervention coordination team) is able to find specific data they seek through simple and clear visual navigation cues, icons, windows, and devices. The interface may further be responsive to audible commands, for example. Because the number of patients a hospital admits each day can be overwhelming, a simple graphical interface that maximizes efficiency and reduce user navigation time is desirable. The visual cues are preferably presented in the context of the problem being evaluated (e.g., readmissions, out-of-ICU, cardiac arrest, diabetic complications, among others).

The dashboard user interface 54 allows interactive requesting of a variety of views, reports and presentations of extracted data and risk score calculations from an operational database within the system. including, for example, summary views of a list of patients in a specific care location; detailed explanation of the components of the various sub-scores; graphical representations of the data for a patient or population over time; comparison of incidence rates of predicted events to the rates of prediction in a specified time frame; summary text clippings, lab trends and risk scores on a particular patient for assistance in dictation or preparation of history and physical reports, daily notes, sign-off continuity of care notes, operative notes, discharge summaries, continuity of care documents to outpatient medical practitioners; order generation to automate the generation of orders authorized by a local care providers healthcare environment and state and national guidelines to be returned to the practitioner's office, outside healthcare provider networks or for return to a hospital or practices electronic medical record; aggregation of the data into frequently used medical formulas to assist in care provision including but not limited to: acid-base calculation, MELD score, Child-Pugh-Turcot score, TIMI risk score, CHADS score, estimated creatinine clearance, Body Surface area, Body Mass Index, adjuvant, neoadjuvant and metastatic cancer survival nomograms, MEWS score, APACHE score, SWIFT score, NIH stroke scale, PORT score, AJCC staging; and publishing of elements of the data on scanned or electronic versions of forms to create automated data forms.

The data presentation and system configuration logic module 52 further includes a messaging interface 56 that is adapted to generate output messaging code in forms such as HL7 messaging, text messaging, e-mail messaging, multimedia messaging, web pages, web portals, REST, XML, computer generated speech, constructed document forms containing graphical, numeric, and text summary of the risk assessment, reminders, and recommended actions. The interventions generated or recommended by the system and method 30 may include: risk score report to the primary physician to highlight risk of readmission for their patients; score report via new data field input into the EMR for use by population surveillance of entire population in hospital, covered entity, accountable care population, or other level of organization within a healthcare providing network; comparison of aggregate risk of readmissions for a single hospital or among hospitals to allow risk-standardized comparisons of hospital readmission rates; automated incorporation of score into discharge summary template, continuity of care document (within providers in the inpatient setting or to outside physician consultants and primary care physicians), HL7 message to facility communication of readmission risk transition to nonhospital physicians; and communicate subcomponents of the aggregate social-environmental score, clinical score and global risk score. These scores would highlight potential strategies to reduce readmissions including: generating optimized medication lists; allowing pharmacies to identify those medication on formulary to reduce out-of-pocket cost and improve outpatient compliance with the pharmacy treatment plan; flagging nutritional education needs; identifying transportation needs; assessing housing instability to identify need for nursing home placement, transitional housing, or Section 8 HHS housing assistance; identifying poor self regulatory behavior for additional follow-up phone calls; identifying poor social network scores leading to recommendation for additional in home RN assessment; flagging high substance abuse score for consultation of rehabilitation counselling for patients with substance abuse issues.

This output may be transmitted wirelessly or via LAN, WAN, the Internet, and delivered to healthcare facilities' electronic medical record stores, user electronic devices (e.g., pager, text messaging program, mobile telephone, tablet computer, mobile computer, laptop computer, desktop computer, and server), health information exchanges, and other data stores, databases, devices, and users. The system and method 30 may automatically generate, transmit, and present information such as high-risk patient lists with risk scores, natural language generated text, reports, recommended actions, alerts, Continuity of Care Documents, flags, appointment reminders, and questionnaires.

The data presentation and system configuration logic module 52 further includes a system configuration interface 58. Local clinical preferences, knowledge, and approaches may be directly provided as input to the predictive models through the system configuration interface 56. This system configuration interface 56 allows the institution or health system to set or reset variable thresholds, predictive weights, and other parameters in the predictive model directly. The system configuration interface 58 preferably includes a graphical user interface designed to minimize user navigation time.

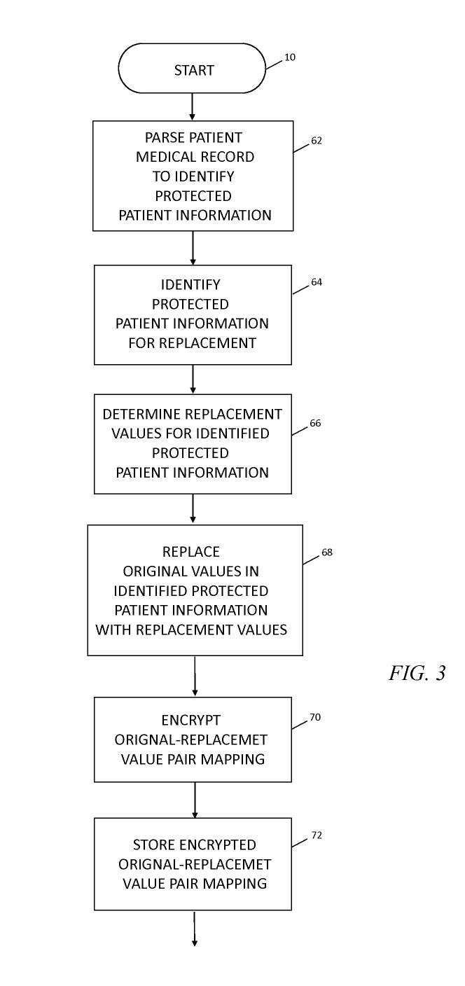

FIG. 3 is a simplified flowchart of an exemplary embodiment of a patient protected information de-identification system and method 10 according to the present disclosure. The goal of the de-identification process 10 is to replace all instances of protected information in a patient's medical record, but to do it in a way that is fast and difficult to detect and reverse engineer. In block 62, documents within the patient's medical record are parsed to identify protected health information. A medical record may include all of the patient's clinical and non-clinical data described above that may include structured forms with well-identified data fields as well as free-form text. For example, a patient intake form that is filled out when the patient is first admitted to a hospital may include data fields that are known and organized in a known manner. The parsing process may use the knowledge gained from parsing such structured documents to process data in the rest of the medical record. For example, it may be known that the first data field in the structured document contains a text string that represents the patient's last name, the second data field contains a text string that represents the patient's first name, the fourth data field contains a text string that represents the patient's date of birth, the fifth data field contains a text string that represents the admission date, the seventh data field contains a text string that represents the patient's street address, and the eighth data field contains a text string that represents the patient's city, etc. By parsing this structured document and acquiring the data in the document, the de-identification system and method generates a dictionary of target patient data in the medical record that is used to intelligently pinpoint protected health information in the patient's medical record that should be replaced or anonymized, as shown in block 64. This parsing step may also further include algorithms that analyze the parsed documents to aid in identifying the protected health information. For example, it can recognize text strings that resemble telephone numbers, electronic mail addresses, zip codes, dates, etc. and incorporate those text strings in the dictionary.

The intelligent precision methodology described herein is in stark contrast with conventional methods that process one document at a time without knowledge of the entire corpus of information in the patient's medical record. These conventional methods do not have any awareness of the patient's name, for example, when it searches through a document from that patient's medical record. It instead conducts the search by looking for names that it recognizes as a name, for example, by consulting a list of known names. Therefore, conventional methods are done in a more brute force fashion that is more error prone.

For example, if by parsing one or more structured document in the patient's medical record it is deduced that the patient is Mary Jones, with a birthdate on Jan. 23, 1957, and living at 123 Hollywood Road, Dallas, Tex. 75202, then the de-identification process may intelligently hunt for instances of these specific data in the medical record. This intelligent way of searching for instances of protected information is especially effective when the data is not a commonly encountered word. Some non-Anglo names such as names that originate from some Asian countries, for example, may be more difficult to spot, such as Chitra Chaudhri, Anh Mai Tran, and Weilian Chung. Therefore, when given the information from parsing the structure document that the patient's name is Weilian Chung, then the process may search and find the name with much more precision. The process preferably also consults one or more glossaries to look for spelling variations of the protected information to account for spelling and typo errors. For example, a glossary may list words with their commonly mis-spelled variations, so that searching for “Mary Jones” may also result in searches for “Maary Jones” and “Mery Jones,” for example. Further, the process may also consult a glossary to identify a word or term that is commonly exchanged or substituted by another term. For example, because “Rich” and “Dick” are common nicknames for the name “Richard,” the process will also look for those known common substitutes in Richard McDonald's medical record. The parse and identification steps in blocks 62 and 64 may also analyze the surrounding data and text to try to deduce the context of the data to further aid in correctly pinpointing the protected information. Once a piece of protected information is identified, then a replacement value is determined as a substitute for the original value of the protected information, as shown in block 66. In block 68, the original value of the protected information in the medical record is then replaced with the selected replacement value.

The replacement value for a piece of protected information may be determined two ways. The first way is to assign a random replacement value. For example, a glossary or list of replacement female names and a glossary or list of replacement male names may be used to determine a replacement name for a patient. The names may be obtained from the appropriate list according to a randomization algorithm, for example. Alternatively, a replacement value may be selected according to a predetermined set of criteria for the specific type of data item. For example, a patient of Asian Pacific Islander race may be assigned a replacement name that is characteristic of the Asian origin. Further examples include replacing the patient's birth month and date with a month and date combination that is within, for example, six months of the original birthdate, and replacing the patient's city with the name of another city that is geographically in the same region but randomly assigned (versus one-to-one mapping). In each replacement, it is desirable to introduce a random factor that makes the mapping to the replacement value difficult to reverse engineer.

For example, the original clinical note may include “Ms. Nora Jones is a . . . ” and conventional methods would de-identify this text as “Ms. **NAME[AAA] is a . . . ” In contrast, the novel method described herein de-identifies this text as “Ms. Dorothy Campbell is a . . . ” The conventional approach explicitly reveals information about how the algorithm works and what information has been replaced. The method described herein leaves no obvious clue as to what information has been replaced and thus what information has not been replaced. This makes it highly challenging to reverse engineer by malicious entities. Therefore, the new method not only de-identifies the patient data that satisfies the safe harbor exception, but it also does it in a way that makes it difficult to tell whether a particular medical record has undergone the de-identification process because it leaves no telltale signs of de-identification.

In blocks 70 and 72, the original value and the original-replacement value pair mapping are then encrypted and stored separately from the electronic medical record in a secure manner. For example, firewall, intrusion prevention systems, and other devices may be employed as a security measure to guard against unauthorized access and tampering. The mapping may include a pointer that links the replacement value and the original value, for example. In this way, each instance of protected information in the medical record is located and swapped out with “fake” replacement data that can no longer be used to identify the true identity of the patient. The de-identification process 10 therefore disassociates the medical record data from the patient's identity to comply with HIPAA regulations so that the data may be transmitted over wired or wireless network links that may be breached or otherwise compromised. Medical information that has been de-identified, even if accessed by unauthorized persons or entities, cannot be easily linked back to the patient's identity, thus protecting the patient's privacy.

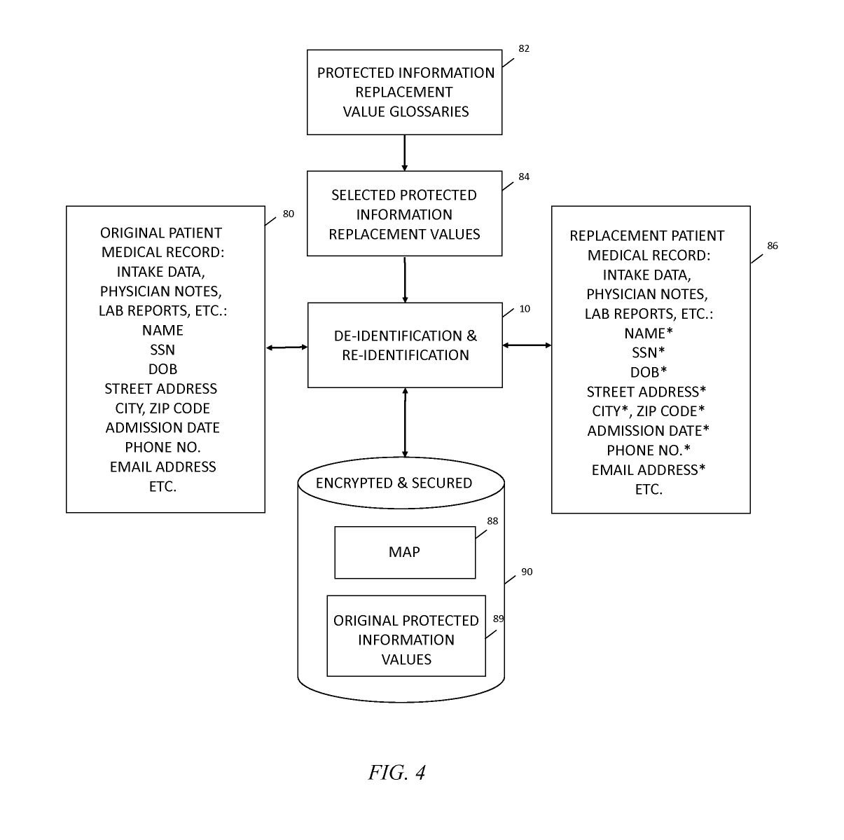

FIG. 4 is another simplified diagram of an exemplary embodiment of a patient protected information de-identification system and method 10 according to the present disclosure. The de-identification system and method 10 receives the original patient medical record 80 that includes a variety of documents, including intake documents, physician notes, diagnosis, treatment plan, prescriptions, laboratory reports, etc. These documents include many instances of protected health information that HIPAA regulations have identified. As described above, the patient protected information de-identification process 10 is configured to find each instance of protected health information and replace each instance with a replacement value that is either randomly assigned and/or selected according to a predetermined algorithm, as described above. The process 10 may access one or more glossaries of replacement values 82 that contain data 84 that may be selected to replace the identified instances of protected information. As a result of de-identification, a patient medical record with replaced information 86 is produced, along with a set of original values 88 and a mapping 89 of the original values to the replacement values in the medical record that are encrypted and stored in a secure computer system or database 90.

The patient protected information de-identification process 10 may also operate in the reverse to return the medical record to its original state. The process 10 locates and extracts the replacement values and repopulates the medical record with the original protected information.

According to the foregoing, the patient protected information de-identification process 10 is operable to disassociate the medical record data from the patient's identity to comply with HIPAA regulations. The process 10 is configure to intelligently parse all of the documents in the medical record to identify all instances of protected information and assign believable or plausible replacement values so that the anonymization cannot be easily detected. Because of this precision approach, the entire de-identification process is many thousands of multiples faster than conventional brute force methods. Further, randomness is introduced in determining the replacement value so that reverse engineering is difficult. Further, all instances of protected information in a patient's medical record are replaced with values in a consistent manner.

The features of the present invention which are believed to be novel are set forth below with particularity in the appended claims. However, modifications, variations, and changes to the exemplary embodiments described above will be apparent to those skilled in the art, and the patient protected information de-identification system and method described herein thus encompasses such modifications, variations, and changes and are not limited to the specific embodiments described herein.

What is claimed is:

1. A computerized method of removing protected health information from a patient's medical record, comprising:
parsing at least one document of a patient's medical record having structured data fields containing the patient's protected health information;
generating a dictionary of target patient data that are protected health information;
searching and identifying the medical record for all instances of target patient data in the dictionary;
for each identified instance of target patient data in the medical record:
determine a random replacement value;
replace the target patient data in the medical record with the replacement value; and
encrypt and store each unique target patient data and a map to its corresponding replacement value;
until all instances of identified target patient data have been replaced with replacement values; and
generating a patient's medical record with replacement values in place of all instances of identified target patient data.

2. The computerized method of claim 1, wherein determining a random replacement value comprises randomly selecting a replacement value from a list according to a set of predetermined criteria.

3. The computerized method of claim 1, wherein determining a random replacement value comprises selecting a random replacement value according to a set of predetermined criteria.

4. The computerized method of claim 1, wherein determining a random replacement value comprises selecting a random replacement date value within six months of a date associated with the patient.

5. The computerized method of claim 1, wherein parsing at least one document comprises parsing a plurality of documents from the patient's medical record containing protected health information.

6. The computerized method of claim 5, further comprising analyzing results from parsing the plurality of documents to identify protected health information.

7. The computerized method of claim 1, further comprising analyzing results from parsing the at least one document to identify protected health information.

8. A computerized method of de-identifying a patient's electronic medical record to replace protected health information, comprising:
receiving a dictionary of target patient data generated from parsing a plurality of documents from the patient's medical record containing protected health information;
searching and identifying the medical record for all instances of target patient data in the dictionary;
for each identified instance of target patient data in the medical record:
determine a plausible random replacement value;
replace the target patient data in the medical record with the replacement value; and
encrypt and store each unique target patient data and its corresponding replacement value;
until all instances of identified target patient data have been replaced with replacement values; and
generating a patient's medical record with replacement values in place of all instances of target patient data.

9. The computerized method of claim 8, wherein determining a random replacement value comprises randomly selecting a replacement value from a list according to a set of predetermined criteria.

10. The computerized method of claim 8, wherein determining a random replacement value comprises selecting a random replacement value according to a set of predetermined criteria.

11. The computerized method of claim 8, wherein determining a random replacement value comprises selecting a random replacement date value within six months of a date associated with the patient.

12. The computerized method of claim 8, further comprising parsing a plurality of documents from the patient's medical record containing protected health information.

13. The computerized method of claim 12, further comprising analyzing results from parsing the plurality of documents to identify protected health information.

14. The computerized method of claim 8, further comprising analyzing results from parsing the at least one document to identify protected health information.

15. A system for de-identifying a patient's medical record, comprising:
a first database configured to store electronic medical records of a plurality of patients, the electronic medical records including protected health information of the patients;
a computer server configured to access the electronic medical records stored in the first database and to:
parse a plurality of documents from a patient's medical record containing the patient's protected health information;
generate a dictionary of target patient data that are protected health information;
search and identify the medical record for all instances of target patient data in the dictionary;
for each identified instance of target patient data in the medical record:
determine a random replacement value;
replace the target patient data in the medical record with the replacement value; and
encrypt and store each unique target patient data and a map to its corresponding replacement value in a second database;
until all instances of identified target patient data have been replaced with replacement values; and
generate a patient's medical record with replacement values in place of all instances of target patient data.

16. The system of claim 15, wherein the computer server is further configured to randomly select a replacement value from a list according to a set of predetermined criteria.

17. The system of claim 15, wherein the computer server is further configured to select a random replacement value according to a set of predetermined criteria.

18. The system of claim 15, wherein the computer server is further configured to select a random replacement date value within six months of a protected health information date associated with the patient.

19. The system of claim 15, wherein the computer server is further configured to analyze results from parsing the plurality of documents to identify protected health information.
